(19) United States
(12) Patent Application Publication
(10) Pub. No.: US 2013/0325348 A1
(43) Pub. Date: Dec. 5, 2013

(54) OBTAINING WETTABILITY FROM T1 AND T2 MEASUREMENTS

(71) Applicants: ANDREA VALORI, AL-KHOBAR (SA); MARTIN D. HÜRLIMANN, NEWTON, MA (US); BENJAMIN NICOT, RIO DE JANEIRO (BR); HENRY N. BACHMAN, AL-KHOBAR (SA)

(72) Inventors: ANDREA VALORI, AL-KHOBAR (SA); MARTIN D. HÜRLIMANN, NEWTON, MA (US); BENJAMIN NICOT, RIO DE JANEIRO (BR); HENRY N. BACHMAN, AL-KHOBAR (SA)

(73) Assignee: SCHLUMBERGER TECHNOLOGY CORPORATION, SUGAR LAND, TX (US)

(21) Appl. No.: 13/485,360

(22) Filed: May 31, 2012

(51) Int. Cl. G06F 19/00; G01V 3/32

(52) U.S. Cl. 702/11

(57) ABSTRACT

Systems and methods for quickly determining wettability using a derived relationship between the two Nuclear Magnetic Resonance (NMR) relaxation times T_{1,oil} and T_{2,oil} combined with downhole or laboratory based NMR measurements. The derived relationship between T_{1,oil}, T_{2,oil} and wettability can be developed empirically for example from core-sample data. Once the relationship is defined, it can be used in the field or laboratory to quickly determine wettability from NMR measurements that measure T_{1,oil} and T_{2,oil} directly, or a function depending on them.

### BACKGROUND

Wettability is the preference of a solid to contact one liquid or gas, known as the wetting phase, rather than another. The wetting phase will tend to spread on the solid surface and a porous solid will tend to imbibe the wetting phase, in both cases displacing the nonwetting phase. Rocks can be water-wet, hydrocarbon-wet or intermediate-wet. Wettability is typically discussed in terms of liquids, thus hydrocarbon-wet typically means oil-wet. However the concepts apply also to gas or gas condensate which may adsorb preferentially to the rock pore surfaces. In this document we use the phrase oil-wet to mean any hydrocarbon that preferentially wets the surface relative to water.

Wettability is an important property in the oilfield industry. For example, oil phase wettability gives an effective affinity between oil and the rock material. The more a rock is oil-wet, generally, the more difficult it will be to strip the oil from the rock. Thus oil wettability is an important factor in estimating the reserves and also for planning treatments in order to reduce oil wettability.

Conventionally, reservoir wetting preference can be determined in a laboratory by measuring the characteristics of core plugs in either an Amott imbibition test or a United States Bureau of Mines (USBM) test. However, the conventional methods are relatively time consuming. For example the USBM test method involves bringing a plug to a lab and flushing the sample with oil and water in different steps in order to determine how difficult it is to push oil into and out of the rock.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

According to some embodiments, a method for quickly determining wettability of a rock medium is described. The method includes: receiving nuclear magnetic resonance data representing a sequence of nuclear magnetic resonance measurements made of the rock medium that depend at least upon T₁ and T₂ of a fluid phase such as oil, receiving a predetermined relationship between a function of T₁ and T₂ of the fluid phase, and wettability; and calculating a measure for wettability for the rock medium based on the nuclear magnetic resonance data and the predetermined relationship. According to some embodiments the function is a ratio of T₁ over T₂, and the predetermined relationship is expressed as a mathematical equation, such as a linear or non-linear function, or in the form of a look-up table. According to some embodiments a diffusion contrast between oil and water is used to discriminate between oil and water in the nuclear magnetic resonance measurements. According to some other embodiments, doped water is introduced into the rock medium prior to the nuclear magnetic resonance measurements, such that the water phase relaxation times can be more easily distinguished from relaxation times of hydrocarbon. According to some embodiments, the predetermined relationship is derived using a benchmarking study based on samples of media.

According to some embodiments, the rock medium is part of a subterranean hydrocarbon-bearing rock formation traversed by at least one well bore, and the nuclear magnetic resonance measurements are made using wireline tools and/or logging while drilling (LWD) tools. According to some embodiments the nuclear magnetic resonance measurements are made using a low gradient tool having a low diffusion effect, such as with an LWD-based tool.

According to some embodiments a system for evaluating a hydrocarbon-bearing subterranean rock formation is described that includes a nuclear magnetic resonance tool adapted to make measurements of rock formation from a location within a borehole, the measurements depending on T₁ and T₂ of a fluid phase within the rock formation; and a processing system adapted and programmed to determine a value for wettability of the fluid phase of the rock formation adjacent the location based at least in part on measurements from the nuclear magnetic resonance tool combined with a predetermined relationship between T₁ and T₂ of the fluid phase and wettability.

### BRIEF DESCRIPTION OF THE DRAWINGS

The subject disclosure is further described in the detailed description which follows, in reference to the noted plurality of drawings by way of non-limiting examples of embodiments of the subject disclosure, in which like reference numerals represent similar parts throughout the several views of the drawings, and wherein:

FIG. 1 is a plot showing a function of T₁ and T₂ for oil plotted against a wettability index, according to some embodiments;

FIG. 2 is a flow chart showing aspects of using a predetermined relationship to calculate wettability from NMR measurements depending on T₁ and T₂, according to some embodiments;

FIG. 3 illustrates a wellsite and related systems for using a predetermined relationship to calculate wettability from NMR measurements depending on T₁ and T₂, according to some embodiments;

FIG. 4 illustrates a wellsite system in which the techniques described herein can be employed, according to some embodiments; and

FIG. 5 shows further detail of a device for formation evaluation while drilling using pulsed nuclear magnetic resonance, according to some embodiments.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details of the subject disclosure in more detail than is necessary for the fundamental understanding of the subject disclosure, the description taken with the drawings making apparent to those skilled in the art how the several forms of the subject disclosure may be embodied in practice. Further, like reference numbers and designations in the various drawings indicate like elements.

According to some embodiments techniques are described herein for using a relationship between the two Nuclear Magnetic Resonance (NMR) relaxation times T_{1,oil} and T_{2,oil} to get information on wettability. Specific examples are described herein. However, in general, this relationship can be extracted from any measurement depending on both T₁ and T₂. According to some embodiments, these techniques are carried out either downhole or on the surface at a wellsite on log data. According to some other embodiments, these techniques are carried out in a laboratory on the surface using samples of the rock (e.g., rock cores) and/or log data.

According to some embodiments, the techniques herein are based on T₁ and T₂ of the oil fraction in a rock being affected differently by the wetness status of the rock. In particular T₂ is much more dependent on the rock wetness than T₁.

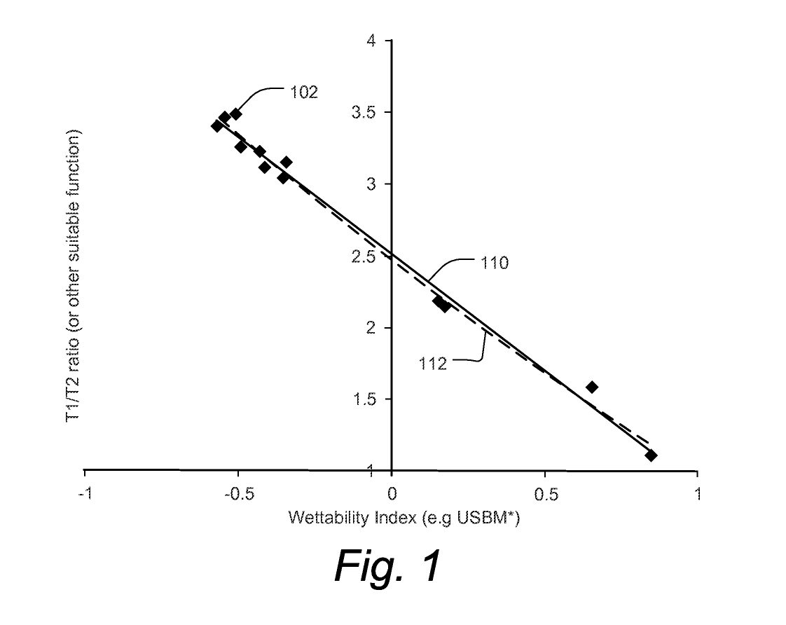

FIG. 1 is a plot showing a function of T₁ and T₂ for oil plotted against a wettability index, according to some embodiments. The data shown in FIG. 1 has been synthesized so as to more clearly illustrate certain aspects described herein. According to one example, the vertical axis shows an average T₁/T₂ ratio of the oil fraction plotted over conventionally determined wettability, such as the USBM wettability index on the horizontal axis. Each sample is shown by one of the diamond shaped markers such as marker 102. It has been found that the average T₁/T₂ ratio increases as the oil wetness of the rock increases. FIG. 1 illustrates the relationship. In the shown example the average T₁/T₂ of the oil phase is correlated to a rescaled (between −1 and 1) version of the USBM wettability index.

According to some embodiments, the oil phase can be separated from the water phase by doping the brine and the T₁/T₂ ratio determined from a 2D T₁-T₂ experiment. In the illustrative plot shown in FIG. 1, the changes in T₁/T₂ is more than a factor of 2 and therefore is not likely to be highly sensitive to various different types of processing that may be used. Using the data, according to some embodiments, an empirical relationship is determined. In the example of FIG. 1, the solid line 110 shows a linear relationship between wettability and the ratio T₁/T₂. Other types of relationships can be used, depending on the circumstances. For example, the non-linear curve 112 is shown fit to the data shown in FIG. 1. According to some embodiments the relationship between the function of T₁ and T₂ for oil and oil-phase wettability is expressed in the form of a look-up table instead of a mathematical formula.

According to some embodiments, the empirically determined relationship between wettability and T₁/T₂, such as shown in curves 110 and 112 of FIG. 1 are used to predict wettability of the rock from other T₁/T₂ measurements. But using a predetermined relationship such as from empirical data such as in FIG. 1, a wettability determination can be made much more quickly than when using traditional wettability assessment techniques. Accordingly, it has been found that the overall workflow using the described techniques can save both time and money.

According to some embodiments, other functions depending on T₁ and T₂ can be used to determine a relationship between that function and wettability. Examples of other functions including T₁ and T₂ that can be used include simple variations such as T₂/T₁ or (T₁+T₂)/T₂ as well as other variations.

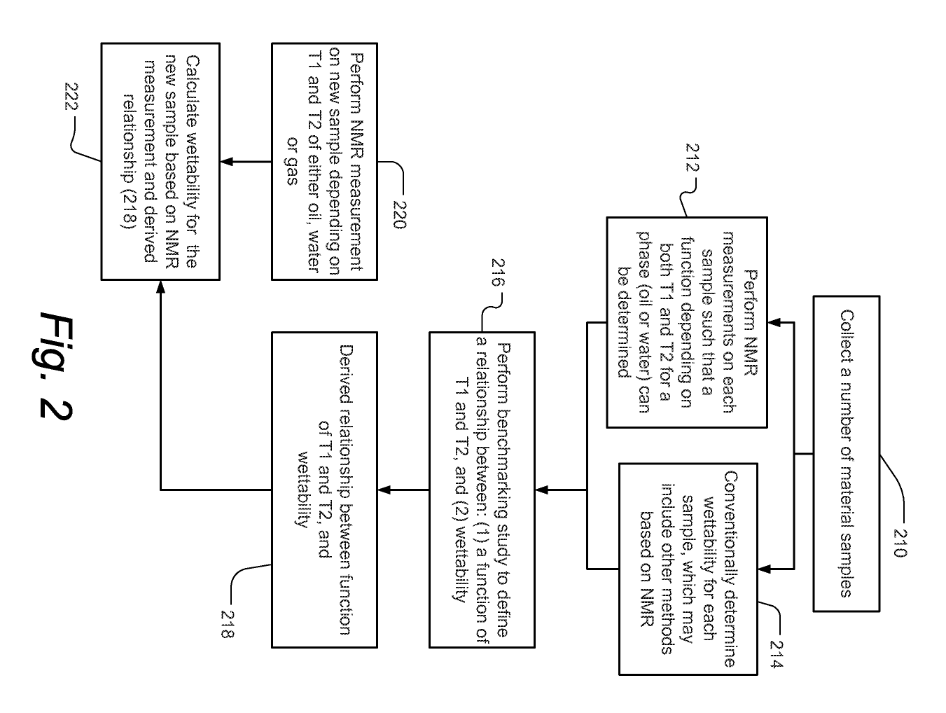

FIG. 2 is a flow chart showing aspects of using a predetermined relationship to calculate wettability from NMR measurements depending on T₁ and T₂, according to some embodiments. In block 210 a number of samples of materials are collected. According to some embodiments the material samples are collected from downhole sources, such as core samples collected from downhole coring operations. According to some embodiments, the samples are taken from a region or formation that is believed to be similar or analogous to the anticipated rock formation where the wettability will be later calculated (in blocks 220 and 222). In block 212 NMR measurements are made on each sample such that a function that depends on both T₁ and T₂ can be calculated. In this example of FIG. 1, the function is simply the ratio of the average T₁/T₂ for the oil phase. As described above, other functions can be used that also depend on both T₁ and T₂.

In block 214, wettability is conventionally measured for each of the material samples collected in block 210. For example, known conventional methods such as a USBM test or an Amott test are used to directly empirically determine wettability of the sample. Wettability can be expressed in a number of ways, including USBM, USBM* and/or the Amott-Harvey index. According to some embodiments, wettability is measured independently by methods that are also based on NMR, such as methods based on T2 alone, T1 alone, or based on the correlations of T1 or T2 with diffusion.

In block 216 a relationship is defined between the function depending on T₁ and T₂ from block 212 on the one hand and the determined wettability from block 214 for each of the collected samples from block 210. The result of step 216 is the defined relationship 218. For example, in FIG. 1 the two curves 110 and 112 are two different examples of relationships determined as described.

Blocks 220 and 222 illustrate the use of the predetermined relationship 218 to quickly determine wettability from NMR measurements of new samples, according to some embodiments. In block 220, an NMR measurement is performed on a new sample. In block 220, the measurement according to some embodiments depends on the T₁ and T₂ signals from just a single phase (e.g., either oil, water or gas). The single-phase measurements can be achieved in many different ways, several of which are described herein. According to some embodiments, the water in the rock is substituted with doped water. Doped water can be generated by dissolving substances that cause the relaxation times of water to change enough to be distinguishable from the oil or gas. The doped water can contain paramagnetic ions that preferentially go into the water rather than the oil or gas. The water will then exhibit very short relaxation times so that it can be easily distinguished from the oil or gas signals. According to some embodiments, doping can be performed downhole or in the laboratory. For further details of methods for the downhole introduction of paramagnetic ions into a water component downhole for NMR measurements, see U.S. Pat. No. 8,076,933, which is incorporated herein by reference.

According to some embodiments, oil (or gas) and water signals can be separated using deuterium oxide (D₂O) in laboratory measurements. In this case the D₂O, also known as heavy water, will be simply invisible to ¹H NMR measurements.

According to some embodiments, the diffusion contrast between (oil or gas) and water can be used to discriminate the two fluids. Correlating diffusion with relaxation allows for a graphical determination of saturations.

While the NMR measurements in block 220 can be made using a suitable wireline tool such as described in U.S. Pat. No. 8,076,933, according to some embodiments an LWD tool can be used to make the NMR measurements in block 220. According to some embodiments, a relatively low-gradient NMR tool such as Schlumberger's proVISION NMR LWD tool is used and the T₁ and T₂ distributions are used to determine which regions are hydrocarbon-rich. NMR measurements from a known hydrocarbon-rich region can then be used to calculate the T₁/T₂ ratio (or other function that depends on both T₁ and T₂) to quickly determine hydrocarbon phase wettability.

In block 222, wettability is calculated for the sample measured in block 220 based on the relationship 218 that is derived in block 216.

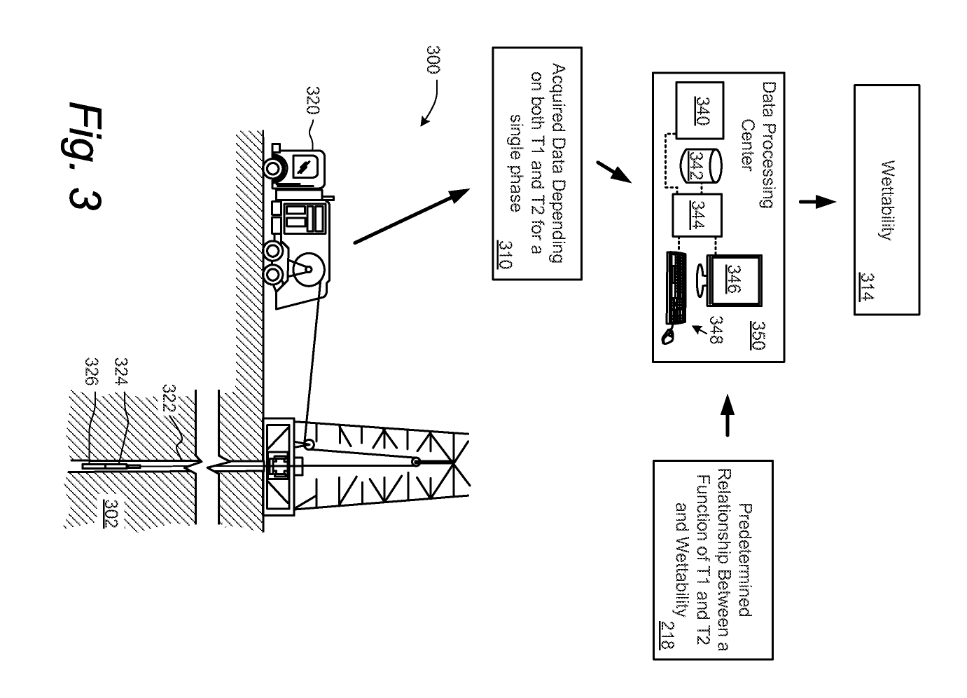

FIG. 3 illustrates a wellsite and related systems for using a predetermined relationship to calculate wettability from NMR measurements depending on T₁ and T₂, according to some embodiments. Data from a subterranean rock formation 302 is being gathered at wellsite 300 via a wireline truck 320 deploying a wireline tool string in well 322. The tool string includes one or more wireline tools such as tools 324 and 326. According to some embodiments, wireline tool 324 is an NMR tool adapted to make NMR measurements downhole, including making measurements that depend on T₁ and T₂ for the oil phase. According to some embodiments an NMR tool such as Schlumberger's CMR Combinable Magnetic Resonance Tool, and/or as described in U.S. Pat. No. 8,076,933 are used.

Acquired data 310 that depends on T₁ and T₂ for the oil phase from NMR tool 324 are transmitted to a processing center 350 which includes one or more central processing units 344 for carrying out the data processing procedures as described herein, as well as other processing. The predetermined relationship 218, as described in FIG. 2, is also transmitted or already resides in the processing center 350. The processing center includes a storage system 342, communications and input/output modules 340, a user display 346 and a user input system 348. According to some embodiments, the processing center 350 may be located in a location remote from the wellsite 300. Data processing center 350 carries out the wettability calculation for the rock in formation 310, such as described in block 222 of FIG. 2, to determine wettability 314 for a location in rock formation 302 much more quickly than using conventional wettability measurement techniques.

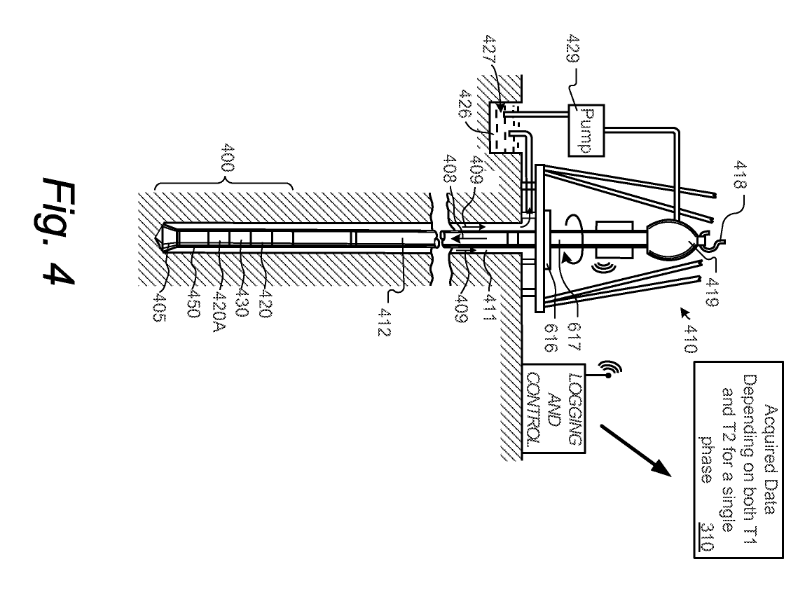

FIG. 4 illustrates a wellsite system in which the techniques described herein can be employed, according to some embodiments. The wellsite can be onshore or offshore. In this exemplary system, a borehole 411 is formed in subsurface formations by rotary drilling in a manner that is well known. Embodiments of the invention can also use directional drilling, as will be described hereinafter.

A drill string 412 is suspended within the borehole 411 and has a bottom hole assembly 400 which includes a drill bit 405 at its lower end. The surface system includes platform and derrick assembly 410 positioned over the borehole 411, the assembly 410 including a rotary table 616, kelly 617, hook 418 and rotary swivel 419. The drill string 412 is rotated by the rotary table 616, energized by means not shown, which engages the kelly 617 at the upper end of the drill string. The drill string 412 is suspended from a hook 418, attached to a traveling block (also not shown), through the kelly 617 and a rotary swivel 419 which permits rotation of the drill string relative to the hook. As is well known, a top drive system could alternatively be used.

In the example of this embodiment, the surface system further includes drilling fluid or mud 426 stored in a pit 427 formed at the well site. A pump 429 delivers the drilling fluid 426 to the interior of the drill string 412 via a port in the swivel 419, causing the drilling fluid to flow downwardly through the drill string 412 as indicated by the directional arrow 408. The drilling fluid exits the drill string 412 via ports in the drill bit 405, and then circulates upwardly through the annulus region between the outside of the drill string and the wall of the borehole, as indicated by the directional arrows 409. In this well-known manner, the drilling fluid lubricates the drill bit 405 and carries formation cuttings up to the surface as it is returned to the pit 427 for recirculation.

The bottom hole assembly 400 of the illustrated embodiment, a logging-while-drilling (LWD) module 420, a measuring-while-drilling (MWD) module 430, a roto-steerable system and motor, and drill bit 405.

The LWD module 420 is housed in a special type of drill collar, as is known in the art, and can contain one or a plurality of known types of logging tools. It will also be understood that more than one LWD and/or MWD module can be employed, e.g., as represented at 420A. (References, throughout, to a module at the position of 420 can alternatively mean a module at the position of 420A as well.) The LWD module includes capabilities for measuring, processing, and storing information, as well as for communicating with the surface equipment. In the present embodiment, the LWD module includes a nuclear magnetic resonance measuring device.

The MWD module 430 is also housed in a special type of drill collar, as is known in the art, and can contain one or more devices for measuring characteristics of the drill string and drill bit. The MWD tool further includes an apparatus (not shown) for generating electrical power to the downhole system. This may typically include a mud turbine generator powered by the flow of the drilling fluid, it being understood that other power and/or battery systems may be employed. In the present embodiment, the MWD module includes one or more of the following types of measuring devices: a weight-on-bit measuring device, a torque measuring device, a vibration measuring device, a shock measuring device, a stick slip measuring device, a direction measuring device, and an inclination measuring device.

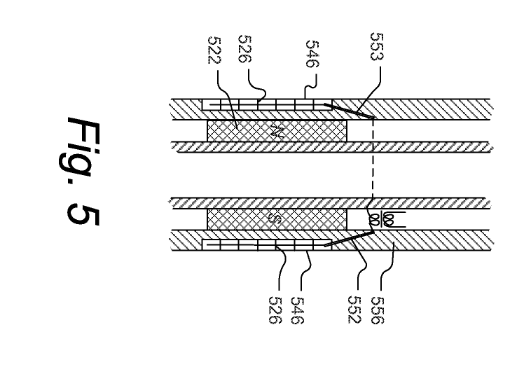

FIG. 5 shows an embodiment of a type of device described in U.S. Pat. No. 5,629,623 for formation evaluation while drilling using pulsed nuclear magnetic resonance (NMR), incorporated herein by reference, it being understood that other types of NMR/LWD tools can also be utilized as the LWD tool 420 or part of an LWD tool suite 420A. As described in the '623 Patent, an embodiment of one configuration of the device comprises a modified drill collar having an axial groove or slot that is filled with ceramic insulator, and contains RF antenna 526, which is protected by a non-magnetic cover 546, and produces and receives pulsed RF electromagnetic energy. The conductors of the RF antenna are grounded at one end to the drill collar. At the other end, the conductors are coupled to an RF transformer 556 via pressure feed-throughs 552 and 553. The transformer 556 keeps a 180° phase difference between the currents in diametrically opposite RF conductors. A cylindrical magnet 522 produces a static magnetic field in the formations. The RF antenna can also be arranged so that the drill collar itself produces the oscillating RF magnetic field. The oscillating RF magnetic field, which excites nuclei of substances in the formations, is axially symmetric, to facilitate measurements during rotation of the drill string. According to some embodiments, the NMR/LWD tool shown in FIGS. 4 and 5 transmit acquired data 310 that depends on T₁ and T₂ for the oil phase to a processing center at the surface such as center 350 shown in FIG. 3 which carries out applying the wettability calculations based on the data from the NMR/LWD tool and the predetermined relationship 218 as described herein.

The NMR relaxation rate of a fluid in a porous media has a contribution from the bulk fluid property and from the interaction between the fluid and the surface of the porous media. The wettability conditions affect the surface relaxation, but not the bulk relaxation. According to some embodiments, the bulk properties of the fluid are determined separately, such that it is then possible to subtract the bulk contribution from the measured relaxation properties. The relaxation properties extracted in this way then reflect only the surface interactions, i.e., the term that is sensitive to the wettability conditions.

In many of the embodiments thus far described, we have used distinct relaxation times T₁ and T₂ to characterize the relaxation properties of crude oils. Crude oils are generally complex fluids and typically contain many different molecules with a wide range of molecular sizes. As a consequence, the relaxation decay of crude oils can deviate significantly from a single exponential decay. In such cases, according to some embodiments, distribution of relaxation times f(T₁) and f(T₂) is used to accurately describe the full relaxation behavior. In such cases, the relaxation times T₁ and T₂ in the embodiments described herein can be interpreted as averages over the full distribution of relaxation times.

Although many embodiments are described herein in the context of oil and water, the described techniques are also applicable to other types of fluids, including gases. In general, the techniques described are applicable to gas, and gas condensate since T1 is different from T2 due to surface effects. For example, according to some embodiments, the techniques described herein are used for shale gas applications.

While the subject disclosure is described through the above embodiments, it will be understood by those of ordinary skill in the art that modification to and variation of the illustrated embodiments may be made without departing from the inventive concepts herein disclosed. Moreover, while the preferred embodiments are described in connection with various illustrative structures, one skilled in the art will recognize that the system may be embodied using a variety of specific structures. Accordingly, the subject disclosure should not be viewed as limited except by the scope and spirit of the appended claims.

What is claimed is:

1. A method for determining wettability of a rock medium comprising:
receiving nuclear magnetic resonance data representing a sequence of nuclear magnetic resonance measurements made of the rock medium that depend at least upon T₁ and T₂;
receiving a predetermined relationship between a function of T₁ and T₂ of a fluid phase, and wettability; and
calculating a measure for wettability for the rock medium based on the nuclear magnetic resonance data and the predetermined relationship.

2. A method according to claim 1 wherein the nuclear magnetic resonance data depend on T₁ and T₂ distributions of hydrocarbon within the rock medium, and wherein the predetermined relationship is between a function of T₁ and T₂ for hydrocarbon and wettability.

3. A method according to claim 2 wherein the hydrocarbon is oil.

4. A method according to claim 2 wherein the predetermined relationship relates a ratio of T₁ and T₂ to wettability.

5. A method according to claim 2 wherein the predetermined relationship relates an average ratio of T₁ over T₂ for hydrocarbon to hydrocarbon-phase wettability.

6. A method according to claim 2 wherein the predetermined relationship relates a ratio of T₁ and T₂ for hydrocarbon with wettability using a mathematical formula.

7. A method according to claim 2 wherein the predetermined relationship relates a ratio of T₁ and T₂ for hydrocarbon with hydrocarbon-phase wettability using a linear function.

8. A method according to claim 3 wherein a diffusion contrast between oil and water is used to discriminate between oil and water in the nuclear magnetic resonance measurements.

9. A method according to claim 8 wherein a graphical determination of saturations is made based on a correlation of diffusion with relaxation of the nuclear magnetic resonance data.

10. A method according to claim 1 wherein a doped water is introduced into the rock medium prior to the nuclear magnetic resonance measurements, the doped water being generated by dissolving a substance that causes relaxation times of water to change so as to be distinguishable from relaxation times of hydrocarbon.

11. A method according to claim 3 wherein oil and water signals are separated using D₂O.

12. A method according to claim 1 wherein the nuclear magnetic measurements include a two-dimensional T₁-T₂ experiment thereby generating a T₁-T₂ correlation that forms at least part of the nuclear magnetic resonance data.

13. A method according to claim 1 wherein the nuclear magnetic resonance measurements include a pulse sequence that yield information on both T₁ and T₂ of the fluid phase.

14. A method according to claim 1 wherein the predetermined relationship is derived using a benchmarking study based on samples of media.

15. A method according to claim 1 wherein the rock medium is part of a subterranean rock formation.

16. A method according to claim 15 wherein the subterranean rock formation is a hydrocarbon-bearing formation traversed by at least one well bore.

17. A method according to claim 16 wherein the nuclear magnetic resonance measurements where made using one or more wireline tools.

18. A method according to claim 16 wherein the nuclear magnetic measurements were made using an LWD tool during a drilling operation.

19. A method according to claim 1 further comprising identifying a hydrocarbon-rich region of the rock based at least in part on measured T₁ and T₂ distributions; wherein the nuclear magnetic resonance measurements are made at the identified hydrocarbon-rich region.

20. A method according to claim 19 wherein the nuclear magnetic resonance measurements are made using a low gradient tool having a low diffusion effect.

21. A method according to claim 20 wherein the low gradient tool forms part of an LWD module within a drill collar.

22. A method according to claim 1 wherein the method does not rely on fluid extraction from the rock medium.

23. A method according to claim 1 wherein the received nuclear magnetic resonance data is calculated from a surface component of T₁ and T₂.

24. A method according to claim 1 wherein the fluid phase is a liquid or gas that is distinct from water.

25. A system for evaluating a hydrocarbon-bearing subterranean rock formation comprising:
a nuclear magnetic resonance tool adapted to make measurements of rock formation from a location within a borehole, the measurements depending on T₁ and T₂ of a fluid phase within the rock formation; and
a processing system adapted and programmed to determine a value for wettability of the fluid phase of the rock formation adjacent the location based at least in part on measurements from the nuclear magnetic resonance tool combined with a predetermined relationship between T₁ and T₂ of the fluid phase and wettability.

26. A system according to claim 25 wherein the fluid phase is oil.

27. A system according to claim 25 wherein the fluid phase is gas or gas condensate.

28. A system according to claim 25 wherein the fluid phase is a liquid or gas that is distinct from water.

29. A system according to claim 25 wherein the predetermined relationship relates a ratio of T₁ and T₂ for hydrocarbon with hydrocarbon-phase wettability using a mathematical formula.

30. A system according to claim 29 wherein the predetermined relationship relates a ratio of T₁ and T₂ for hydrocarbon with hydrocarbon-phase wettability using a linear function.

31. A system according to claim 29 wherein the predetermined relationship is generated empirically from a plurality of material samples.

32. A system according to claim 25 wherein the nuclear magnetic resonance tool forms part of a wireline toolstring.

33. A system according to claim 25 wherein the nuclear magnetic resonance tool forms part of a LWD module in a drill collar.

34. A system according to claim 33 wherein the nuclear magnetic resonance tool is a low gradient tool having a low diffusion effect.
